(19) United States
(12) Patent Application Publication
(10) Pub. No.: US 2010/0026628 A1
(43) Pub. Date: Feb. 4, 2010

(54) HANDHELD APPARATUS AND METHOD FOR INPUTTING INFORMATION IN THE HANDHELD APPARATUS

(75) Inventors: HONG-LIANG LIU, Shenzhen City (CN); XIA-FEI CAO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Taipei (TW)

(21) Appl. No.: 12/210,518

(22) Filed: Sep. 15, 2008

(30) Foreign Application Priority Data
Jul. 31, 2008 (CN) 200810303291.6

(51) Int. Cl. G06F 3/02

(52) U.S. Cl. 345/168

(57) ABSTRACT

A handheld apparatus includes an input key, a screen, a monitoring module connected to the input key, and a Morse code decoder connected between the monitoring module and the screen. The monitoring module monitors the state of the input key and generates a corresponding Morse code, and outputs the Morse code to the Morse code decoder. The Morse code decoder decodes the Morse code into information and outputs the information to the screen. The screen displays the information. The present invention further includes a method of inputting information in the handheld apparatus.

### BACKGROUND

1. Technical Field

The present invention relates to a handheld apparatus and a method for inputting information in the handheld apparatus.

2. Description of Related Art

Mobile phones have become increasingly popular and the trend for creating a smaller phone with a large screen display is growing. Nowadays, the mobile phone is equipped with a variety functions, such as taking photos, playing games, and playing video. Therefore, the mobile phone requires a large screen to adequately support these functions.

The mobile phone also must have a plurality of keys configured to input information. A typical mobile phone has a numeric keypad for dialing for dialing and corresponding to English letters for inputting text. These keys occupy a large area of the mobile phone, which limit the usable area for a display screen. Therefore, a new handheld apparatus is desired to overcome the above-described deficiency.

### BRIEF DESCRIPTION OF THE DRAWINGS

FIG. 1 is a top plan view of an embodiment of a handheld apparatus.

FIG. 2 is a block diagram of the handheld apparatus of FIG. 1.

FIG. 3 is a flow chart of an embodiment of a method for inputting information in the handheld apparatus of FIG. 1.

### DETAILED DESCRIPTION OF THE EMBODIMENTS

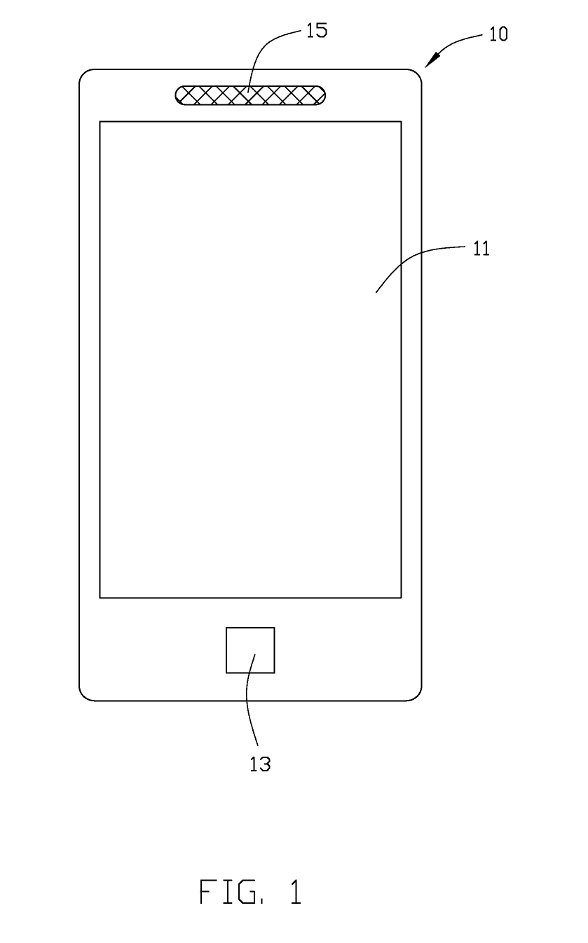

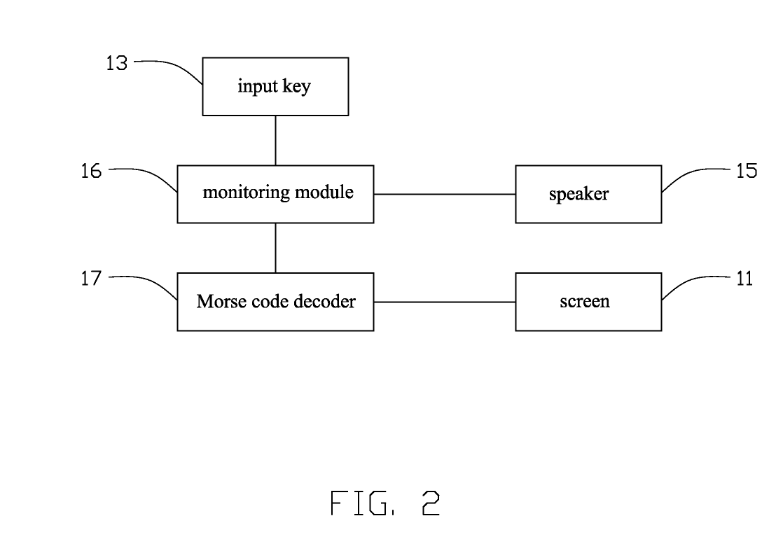

Referring to FIG. 1, an embodiment of a handheld apparatus 10 includes a screen 11 and an input key 13. In the illustrated embodiment, the handheld apparatus 10 further includes a speaker 15. Referring to FIG. 2, the handheld apparatus 10 further comprises a monitoring module 16 and a Morse code decoder 17. The monitoring module 16 is connected to the input key 13 and configured to monitor the input key 13 and generate Morse code corresponding to different states of the input key 13. Morse code is a character encoding using standardized sequences of short and long elements to represent the letters, numerals, punctuation and special characters of a given message. For example, if the input key 13 is pressed down for a duration time between about 0.08 seconds to about 0.12 seconds, the monitoring module 16 generates a short Morse code element. If the duration time of the input key 13 is pressed down for a duration time between about 0.28 seconds to about 0.32 seconds, the monitoring module 16 generates long Morse code element. If the input key 13 is pressed down for a duration time not within the above two ranges, the monitoring module 16 does not generate anything.

The monitoring module 16 is further preconfigured with a time interval, for example 0.5 seconds. Each Morse code element is separated by the time interval. In other words, each time interval that elapses indicates that a letter, numeral, punctuation, or special character has been completed. The monitoring module 16 monitors if the input key 13 is pressed within the time interval after the input key 13 is released. If the input key 13 is not pressed again within the time interval, a string of Morse code input has been completed. For example, to input a word “so”, the Morse code corresponding to the letter “s” is created from three short Morse code elements followed by the time interval, and then the Morse code corresponding to the letter “o” is created from three long Morse code elements.

The speaker 15 is connected to the monitoring module 16, and outputs a first sound, such as a “dit,” for the short Morse code element, and outputs a second sound, such as “dah,” for the long Morse code element. The Morse code decoder 17 is connected to the monitoring module 16 and configured to decode Morse code. The screen 11 is connected to the Morse code decoder 17 and configured for displaying the information decoded by the Morse code decoder 17.

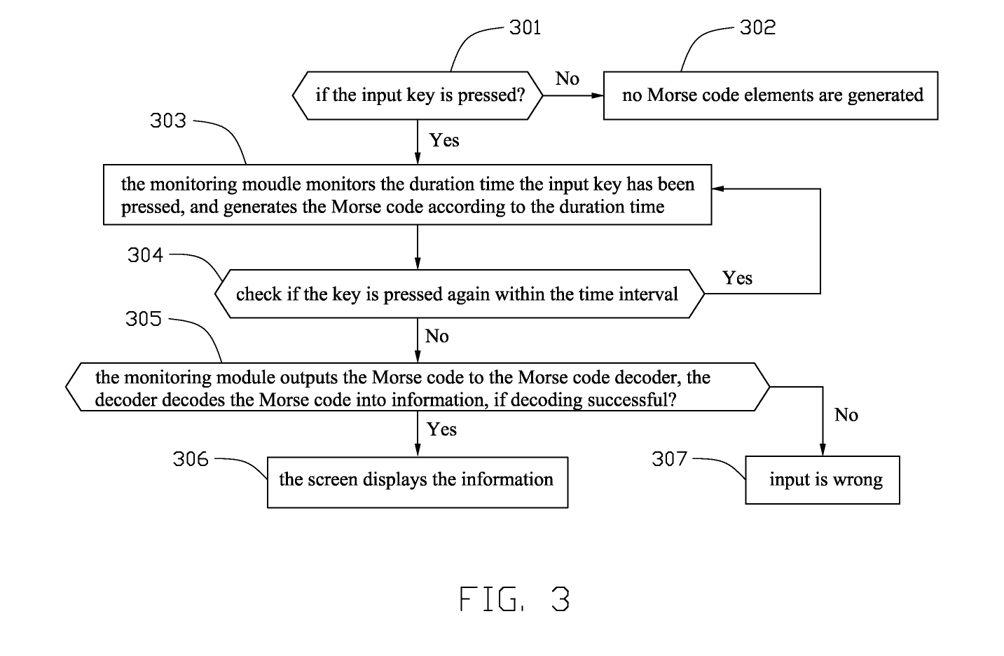

Referring to FIG. 3, is a method for inputting information in the handheld apparatus 10. Depending on the embodiment, certain of the steps described below may be removed, others may be added, and the sequence of steps may be altered.

In a decision step 301, the monitoring module 16 detects if the input key 13 is pressed. If the input key 13 is not pressed, then the method continues to a step 302. If the input key 13 is pressed, then the method continues to a step 303.

In a step 302, if the input key 13 is not pressed, then no Morse code elements are generated.

In a step 303, if the input key 13 is pressed, the monitoring module 16 monitors the duration time the input key 13 has been pressed, and generates the Morse code according to the duration time. Simultaneously, the speaker 15 may output the sound corresponding to the Morse code.

Continuing to a decision step 304, the monitoring module 16 monitors if the input key 13 is pressed within the time interval. If the input key 13 is pressed within the time interval, then the method returns to the step 303. If the input key 13 is not pressed within the time interval, then the method continues to a decision step 305.

In a decision step 305, the monitoring module 16 outputs the Morse code to the Morse code decoder 17, the Morse code decoder 17 decodes the Morse code, and determines if the decoding was successful. If the decoding is successful, then the method continues to a step 306. If the decoding was not successful, then the method continues to a step 307.

Moving to a step 306, the Morse code decoder 17 outputs the decoded information to the screen 11, and the screen 11 displays the information.

Continuing to a step 307, the input is wrong (step 307) and the method ends.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A handheld apparatus, comprising:
an input key;
a screen;
a monitoring module connected to the input key; and
a Morse code decoder connected between the monitoring module and the screen;
wherein the monitoring module is configured to monitor the input key, generate a corresponding Morse code corresponding to different states of the input key, and output the Morse code to the Morse code decoder; the Morse code decoder is configured to decode the Morse code into information and output the information to the screen; the screen displays the information.

2. The handheld apparatus of claim 1, wherein a duration time of the input key being pressed corresponding to a short Morse code element is between 0.08 to 0.12 seconds; a duration time of the input key being pressed corresponding to a long Morse code element is between 0.28 to 0.32 seconds.

3. The handheld apparatus of claim 2, wherein the handheld apparatus further comprises a speaker connected to the monitoring module, the speaker outputs a first sound corresponding to the short Morse code element and a second sound corresponding to the long Morse code element.

4. The handheld apparatus of claim 1, wherein the monitoring module comprises a time interval, the time interval is a time span after the input key is released indicating that a string of Morse code is complete; the monitoring module outputs the string of Morse code to the Morse code decoder.

5. A method for inputting information in a handheld apparatus, the handheld apparatus comprising an input key, a Morse code decoder, and a monitoring module connected between the input key and the Morse code decoder, the method comprising:
detecting if the input key is pressed;
monitoring a duration time the input key has been pressed;
generating a Morse code according to the duration time;
determining if a time interval has elapsed after the input key is pressed;
outputting the Morse code to the Morse code decoder if the time interval has elapsed;
decoding the Morse code and determining if the decoding was successful;
outputting the decoded information.

6. The method of claim 5, wherein the handheld apparatus further comprises a speaker connected to the monitoring module; the method further comprising generating a first sound corresponding to a short Morse code element and a second sound corresponding to a long Morse code element.

7. The method of claim 6, wherein a duration time of the input key being pressed between 0.08 to 0.12 seconds corresponds to the short Morse code element, and the duration time of the input key being pressed between 0.28 to 0.32 seconds corresponds to the long Morse code element.

8. The method of claim 5, wherein the handheld apparatus further comprises a screen connected to the Morse code decoder, the Morse code decoder sends the decoded information to the screen, the screen display the decoded information.
